(19) United States
(12) Patent Application Publication
(10) Pub. No.: US 2011/0279456 A1
(43) Pub. Date: Nov. 17, 2011

(54) PROJECTION DISPLAY APPARATUS AND DISPLAY SYSTEM

(75) Inventors: Yoshinao HIRANUMA, Osaka (JP); Masahiro HARAGUCHI, Osaka (JP); Takaaki ABE, Osaka (JP); Masutaka INOUE, Osaka (JP)

(73) Assignee: SANYO ELECTRIC CO., LTD., Moriguchi-shi (JP)

(21) Appl. No.: 13/051,381

(22) Filed: Mar. 18, 2011

Related U.S. Application Data
(63) Continuation of application No. PCT/JP2009/066388, filed on Sep. 18, 2009.

(30) Foreign Application Priority Data
Sep. 19, 2008 (JP) 2008-241525
Sep. 11, 2009 (JP) 2009-210255

(51) Int. Cl. G03B 21/14; G06T 3/40

(52) U.S. Cl. 345/428; 353/85

(57) ABSTRACT

A projection display apparatus is provided with a main body unit comprised of a light source and a projection element for projecting light emitted from the light source to a projection plane. The projection element is provided in the main body unit. The main body unit is further comprised of an adjusting member exclusively used for the operation of an image adjustment function to adjust an image on the projection plane, wherein the image is composed of the light emitted from the projection element.

### TECHNICAL FIELD

The present invention relates to a projection display apparatus and a display system which have a projection element for projecting light emitted from a light source to a projection plane.

### BACKGROUND ART

There has heretofore been known a projection display apparatus having an imager and a projection optical system for projecting light emitted from the imager. The projection display apparatus has an image adjustment function (e.g., a trapezoid correction function) to adjust an image formed on a projection plane such as a screen by the light emitted from the projection optical system.

Generally, the image adjustment function is executed by operating buttons provided on a main body or a remote controller of the projection display apparatus. For example, the image adjustment function is selected by the button operation from a menu screen including a list of various functions. Thereafter, setting of the image adjustment function is performed by the button operation.

Meanwhile, there has recently been proposed a portable projection display apparatus to extend the usage scene of the projection display apparatus (e.g., see Patent Document 1).

Here, an installation location of the portable projection display apparatus is frequently changed. Accordingly, the image adjustment function such as the trapezoid correction function is also frequently used.

In the current projection display apparatus, however, the image adjustment function is positioned in a lower layer of a menu function, and therefore needs to be called, which complicates an operation (such as a button operation) for adjusting an image on the projection plane.

### PRIOR ART DOCUMENT

### Patent Document

### Patent Document 1: Japanese Patent Application Publication No. 2005-123720

### SUMMARY OF THE INVENTION

A projection display apparatus of first aspect includes: a main body unit (main body unit 110) including a light source (solid light source 152) and a projection element (projection element 154) which projects light emitted from the light source to a projection plane. The projection element is provided inside the main body unit. The main body unit further includes an adjusting member (horizontal adjusting member 112 and vertical adjusting member 113) used exclusively for operation of an image adjustment function to adjust an image on the projection plane, the image being formed by the light emitted from the projection element.

In the first aspect, the projection display apparatus according to claim 1, further includes: a supporting member (supporting member 120) which supports the main body unit rotatably around a plurality of axes; and a fixing member (fixing member 150) which fixes the main body unit and the supporting member to installation sites.

In the first aspect, the projection display apparatus according to claim 1, further includes: an image processor which controls the image adjustment function based on an adjustment signal inputted from the adjusting member. The image projected onto the projection plane includes a plurality of pixels each having coordinates determined by a row in the horizontal direction and a column in the vertical direction. The image processor changes the number of pixels in the horizontal direction and the number of pixels in the vertical direction by converting an image signal inputted from an external device.

In the first aspect, the projection display apparatus according to claim 1, further includes: an image processor which controls the image adjustment function based on an adjustment signal inputted from the adjusting member. The image projected onto the projection plane including a plurality of pixels each having coordinates determined by a row in the horizontal direction in the column in the vertical direction. The image processor outputs, as a request to convert the image signal, the adjustment signal inputted from the adjusting member, to an external device. The image processor acquires the converted image signal from the external device. The converted image signal is a signal obtained by changing the number of pixels in the horizontal direction and the number of pixels in the vertical direction.

In the first aspect, the projection display apparatus according to claim 1, further includes: an image processor which controls the image adjustment function based on an adjustment signal inputted from the adjusting member. The light source is a solid light source. The projection element scans the projection plane in a predetermined scanning direction for each of a plurality of pixels each having coordinates determined by a row in the horizontal direction and a column in the vertical direction. The image processor controls a scan angle for the projection element in the predetermined scanning direction.

In the first aspect, the projection display apparatus according to claim 1, further includes: a storage unit which stores projection angles at which the projection element projects the light onto the projection plane and a plurality of correction shapes in association with each other, the plurality of correction shapes obtained by deforming a predetermined reference shape according to the projection angles; and an image processor which controls the light source and the projection element so that at least two or more of the plurality of correction shapes are formed on the projection plane as an image formed by the light projected onto the projection plane.

In the first aspect, the projection display apparatus according to claim 1, further includes: an image processor which controls the light source and the projection element so that an image is formed with the light projected onto the projection plane. The image processor controls the light source and the projection element so that a vertical guide line and a horizontal guide line are formed on the projection plane as a start-up image when the projection display apparatus is started, the vertical guide line forming a vertical line when processing of the image adjustment function is completed and the horizontal guide line forming a horizontal line when processing of the image adjustment function is completed.

A display system of a second aspect includes at least a projection display apparatus including a light source and a projection element which projects light emitted from the light source to a projection plane, the display system further comprising an adjusting member used for operation of an image adjustment function to adjust an image on the projection plane, the image being formed by the light emitted from the projection element. The projection element is provided in the projection display apparatus.

### BRIEF DESCRIPTION OF THE DRAWINGS

FIG. 1 is a diagram showing a configuration of a display system according to a first embodiment.

FIG. 2 is a diagram showing the configuration of the display system according to the first embodiment.

FIG. 3 is a diagram showing the configuration of the display system according to the first embodiment.

FIG. 4 is a diagram showing the configuration of the display system according to the first embodiment.

FIG. 5 is a diagram showing a configuration of a projection display apparatus 100 according to the first embodiment.

FIG. 6 is a diagram showing the configuration of a projection display apparatus 100 according to the first embodiment.

FIG. 7 is a diagram showing functions of the display system according to the first embodiment.

FIG. 8 is a diagram for explaining a trapezoid correction function according to the first embodiment.

FIG. 9 is a diagram for explaining a trapezoid correction function according to the first embodiment.

FIG. 10 is a diagram for explaining a trapezoid correction function according to the first embodiment.

FIG. 11 is a diagram showing a configuration example of an adjusting member according to modified example 1 of the first embodiment.

FIG. 12 is a diagram showing the configuration example of an adjusting member according to modified example 1 of the first embodiment.

FIG. 13 is a diagram showing the configuration example of an adjusting member according to modified example 1 of the first embodiment.

FIG. 14 is a diagram showing the configuration example of an adjusting member according to modified example 1 of the first embodiment.

FIG. 15 is a diagram showing a configuration of a display system according to modified example 2 of the first embodiment.

FIG. 16 is a diagram showing a configuration of a display system according to modified example 3 of the first embodiment.

FIG. 17 is a diagram for explaining a trapezoid correction function according to modified example 3 of the first embodiment.

FIG. 18 is a diagram for explaining the trapezoid correction function according to modified example 3 of the first embodiment.

FIG. 19 is a diagram showing functions of the display system according to a second embodiment.

FIG. 20 is a diagram showing correction shapes according to the second embodiment.

FIG. 21 is a diagram showing a display example of the correction shapes according to the second embodiment.

FIG. 22 is a diagram showing a display example of the correction shapes according to the second embodiment.

FIG. 23 is a diagram showing a display example of the correction shapes according to the second embodiment.

FIG. 24 is a diagram showing a display example of the correction shapes according to the second embodiment.

FIG. 25 is a diagram showing a display example after processing by the trapezoid correction function according to the second embodiment.

FIG. 26 is a diagram showing a display example before processing by a trapezoid correction function according to a third embodiment.

FIG. 27 is a diagram showing a display example after processing by the trapezoid correction function according to the third embodiment.

### EMBODIMENT FOR CARRYING OUT THE INVENTION

A projection display apparatus according to an embodiment of the present invention is described below with reference to the drawings. Note that, in the following description of the drawings, the same or similar parts are denoted by the same or similar reference numerals.

Note that, the drawings are schematic and ratios of dimensions and the like are different from actual ones. Therefore, specific dimensions and the like should be determined in consideration of the following description. Moreover, the drawings also include portions having different dimensional relationships and ratios from each other.

### Overview of Embodiment

The projection display apparatus according to the embodiment is provided with a main body unit including a light source and a projection element for projecting light emitted from the light source to a projection plane. The projection element is provided in the main body unit. The main body unit further includes an adjusting member used exclusively for the operation of an image adjustment function to adjust an image on the projection plane, the image being formed by the light emitted from the projection element.

Note that the projection display apparatus may be a portable projection display apparatus attached to a terminal such as a notebook computer. In such a case, the projection display apparatus may include: a supporting member for rotatably supporting the main body unit around multiple axes; and a fixing member for fixing the main body unit and the supporting member at their installation sites.

As described above, in the projection display apparatus according to the embodiment, the adjusting member used exclusively for the image adjustment function is provided in the main body unit, thereby simplifying the operation for using the image adjustment function.

More specifically, it should be noted in the embodiment that the adjusting member used exclusively for the image adjustment function is provided in the main body unit, focusing on high usage frequency of the image adjustment function in the portable projection display apparatus.

The embodiment is described by taking a trapezoid correction function as an example of the image adjustment function. However, the image adjustment function is not limited to the trapezoid correction function. That is, the image adjustment function needs only be a function to adjust, on the projection plane, the image formed by the light emitted from the projection element.

### First Embodiment

(Configuration of Display System)

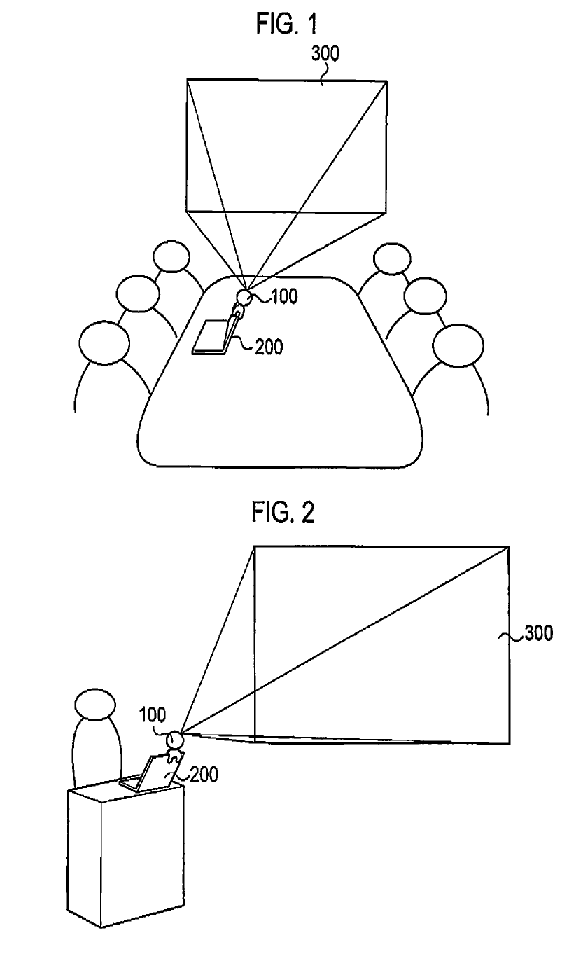

A configuration of a display system according to a first embodiment is described below with reference to the drawings. FIGS. 1 to 3 are diagrams showing the configuration of the display system according to the first embodiment.

As shown in FIGS. 1 to 3, the display system includes a projection display apparatus 100 and a terminal 200 such as a notebook PC. The projection display apparatus 100 is detachably fixed to the terminal 200. The projection display apparatus 100 projects image light to a projection plane 300. The projection plane 300 may be formed of a screen or may be simply formed of a wall surface.

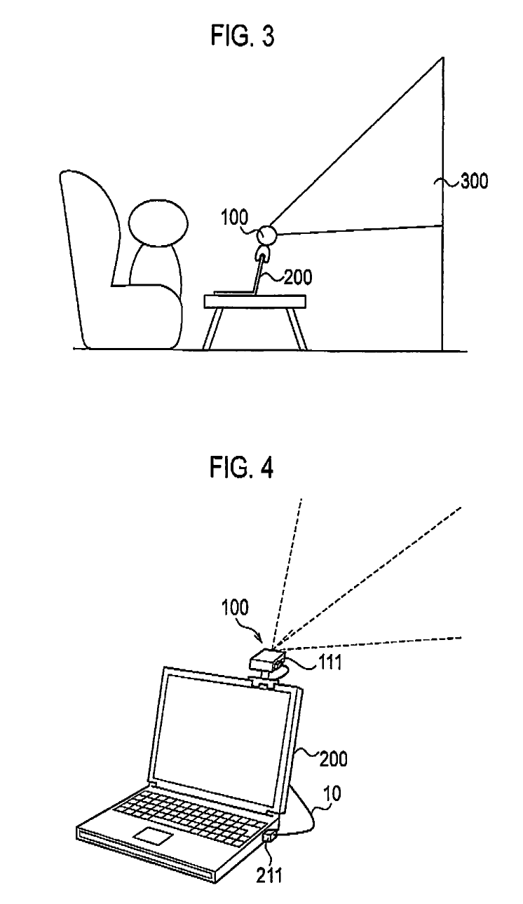

For example, as shown in FIG. 1, the projection display apparatus 100 may be used in a meeting. Also, as shown in FIG. 2, the projection display apparatus 100 may be used in a presentation. Furthermore, as shown in FIG. 3, the projection display apparatus 100 may be used for personal use (home use).

(Configuration of Projection Display Apparatus)

A configuration of a projection display apparatus according to the first embodiment is described below with reference to the drawings. FIGS. 4 to 6 are diagrams showing the configuration of the projection display apparatus 100 according to the first embodiment.

As shown in FIG. 4, the projection display apparatus 100 is detachably fixed to the terminal 200, and is connected to the terminal 200 by a cable 10 such as a USE cable. To be more specific, the projection display apparatus 100 has a port 111, and the terminal 200 has a port 211. The cable 10 connects the port 111 to the port 211. Note that the projection display apparatus 100 may be wirelessly connected to the terminal 200 by Bluetooth or the like.

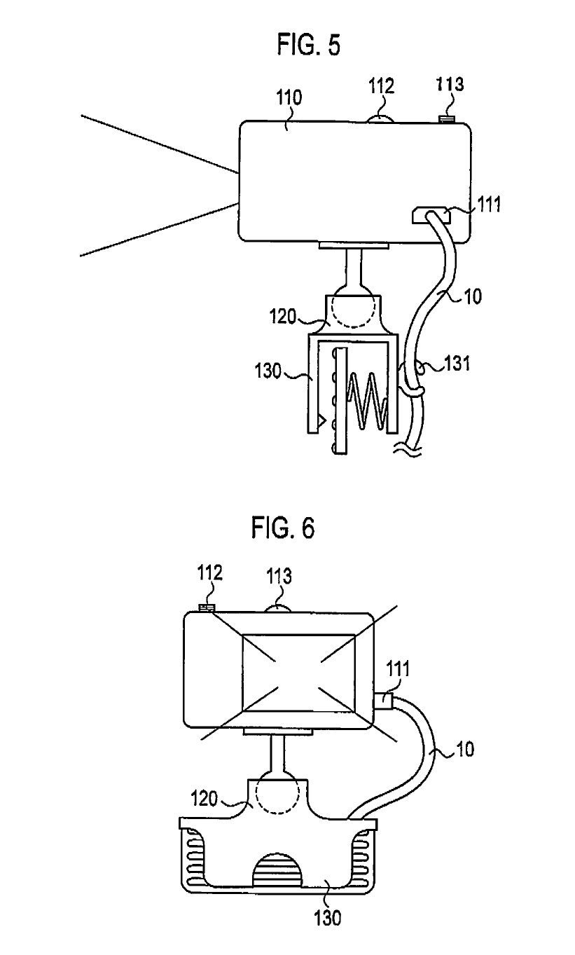

As shown in FIGS. 5 and 6, the projection display apparatus 100 includes a main body unit 110, a supporting member 120 and a fixing member 130. Note that FIG. 5 is a diagram of the projection display apparatus 100 viewed from the side, while FIG. 6 is a diagram of the projection display apparatus 100 viewed from the front.

As described later, the main body unit 110 includes a solid light source 152 and a projection element 154 for projecting light emitted from the solid light source 152 to the projection plane 300. The main body unit 110 has the port 111 described above. The main body unit 110 further includes a horizontal adjusting member 112 and a vertical adjusting member 113.

The horizontal adjusting member 112 and the vertical adjusting member 113 are used exclusively for a trapezoid correction function to correct, on the projection plane 300, a shape of an image formed by light emitted from the projection element 154. The image formed by the light emitted from the projection element 154 includes multiple pixels each having coordinates determined by a row in the horizontal direction and a column along the vertical direction.

In the first embodiment, the horizontal adjusting member 112 is used to change the number of pixels in the horizontal direction. Here, the horizontal adjusting member 112 is configured to be rotatable. As described later, thinning of the pixels in the horizontal direction or pixel interpolation in the horizontal direction is performed by rotating the horizontal adjusting member 112. Specifically, the number of pixels in the horizontal direction is changed for each row by rotating the horizontal adjusting member 112.

Note that the horizontal adjusting member 112 outputs a horizontal adjustment signal indicating the degree of the change of the pixels in the horizontal direction in response to the rotation of the horizontal adjusting member 112.

In the first embodiment, the vertical adjusting member 113 is used to change the number of pixels in the vertical direction. Here, the vertical adjusting member 113 is configured to be rotatable. As described later, thinning of the pixels in the vertical direction or pixel interpolation in the vertical direction is performed by rotating the vertical adjusting member 113. Specifically, the number of pixels in the vertical direction is changed for each column by rotating the horizontal adjusting member 112.

Note that the vertical adjusting member 113 outputs a vertical adjustment signal indicating the degree of the change of the pixels in the vertical direction in response to the rotation of the vertical adjusting member 113.

The supporting member 120 rotatably supports the main body unit 110. The supporting member 120 supports the main body unit 110 so that the main body unit 110 is rotatable around at least a horizontal axis and a vertical axis. In the first embodiment, the supporting member 120 supports the main body unit 110 so that the main body unit 110 is rotatable around any axis (free axis).

The fixing member 130 is a member for fixing the main body unit 110 and the supporting member 120 to the terminal 200, and is, for example, a clip and the like. Here, the fixing member 130 is formed integrally with the supporting member 120. Note that the fixing member 130 has a latch 131 for latching the cable 10.

(Functions of Display System)

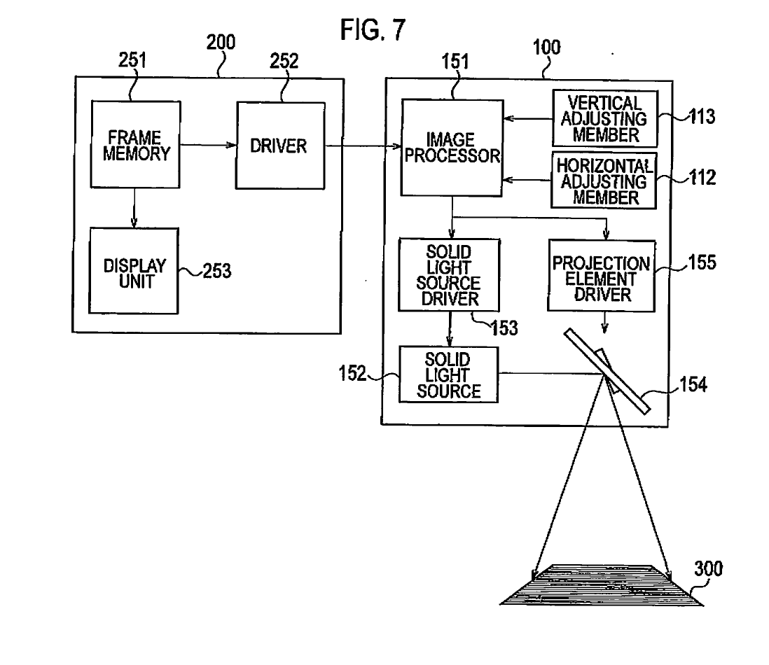

Functions of the display system according to the first embodiment are described below with reference to the drawing. FIG. 7 is a diagram showing the functions of the display system according to the first embodiment. As described above, the display system includes the projection display apparatus 100 and the terminal 200.

As shown in FIG. 7, the terminal 200 includes a frame memory 251, a driver 252 and a display unit 253.

The frame memory 251 stores an image signal for each of a plurality of pixels making up one frame. The image signal includes, for example, R, G and B signals.

The driver 252 outputs to the projection display apparatus 100 the image signal of the plural pixels making up one frame. Specifically, the driver 252 outputs the image signal through the cable 10 (not shown). As described above, the image signal includes, for example, the R, G and B signals.

The display unit 253 displays an image of one frame based on the image signal stored in the frame memory 251. Note that the image displayed on the display unit 253 is preferably coincided with an image to be projected on the projection plane 300.

As shown in FIG. 7, the projection display apparatus 100 includes an image processor 151, the solid light source 152, a solid light source driver 153, the projection element 154 and a projection element driver 155. The projection display apparatus 100 further includes the horizontal adjusting member 112 and the vertical adjusting member 113.

The image processor 151 processes the image signal acquired from the terminal 200. The image processor 151 has a trapezoid correction function, a gamma correction function and the like.

Here, the image processor 151 acquires a horizontal adjustment signal from the horizontal adjusting member 112. Likewise, a vertical adjustment signal from the vertical adjusting member 113.

The image processor 151 controls the trapezoid correction function based on the horizontal adjustment signal inputted from the horizontal adjusting member 112 and the vertical adjustment signal inputted from the vertical adjusting member 113. To be more specific, the image processor 151 converts the image signal based on the horizontal adjustment signal and the vertical adjustment signal, the image signal being acquired from the terminal 200. In other words, the image processor 151 controls the trapezoid correction function.

The image processor 151 performs, for example, thinning of the pixels in the horizontal direction, pixel interpolation in the horizontal direction, or the like in response to the horizontal adjustment signal. Likewise, the image processor 151 performs thinning of the pixels in the vertical direction, pixel interpolation in the vertical direction, or the like in response to the vertical adjustment signal.

The solid light source 152 is an LED (Laser Emitting Diode), an LD (Laser Diode) or the like. The solid light source 152 includes a red solid light source, a green solid light source and a blue solid light source. The solid light source of each color may be an array light source including multiple solid light sources.

The solid light source driver 153 controls the solid light source 152 based on the image signal. Specifically, the solid light source driver 153 controls an amount of red component light emitted from the red solid light source by controlling drive power for the red solid light source based on the R signal. The solid light source driver 158 controls an amount of green component light emitted from the green solid light source by controlling drive power for the green solid light source based on the G signal. The solid light source driver 153 controls an amount of blue component light emitted from the blue solid light source by controlling drive power for the blue solid light source based on the B signal.

The projection element 154 projects the light emitted from the solid light source driver 153 to the projection plane 300. Specifically, the projection element 154 sequentially scans the projection plane 300 for each of a plurality of pixels in a predetermined scanning direction. The predetermined scanning direction may be the horizontal direction or vertical direction.

The projection element driver 155 controls the projection element 154 in response to the image signal. The projection element driver 155 controls the projection element 154 so that the scanning can take a round per frame.

Here, even when the number of pixels in the horizontal direction is changed by the conversion of the image signal by the image processor 151, an oscillation angle of a mirror provided in the projection element 154 is kept constant. Note however that an interval between adjacent pixels in the horizontal direction is changed by the change in the number of pixels in the horizontal direction.

Similarly, even when the number of pixels in the vertical direction is changed by the conversion of the image signal by the image processor 151, the oscillation angle of the mirror provided in the projection element 154 is kept constant. Note however that an interval between adjacent pixels in the vertical direction is changed by the change in the number of pixels in the vertical direction.

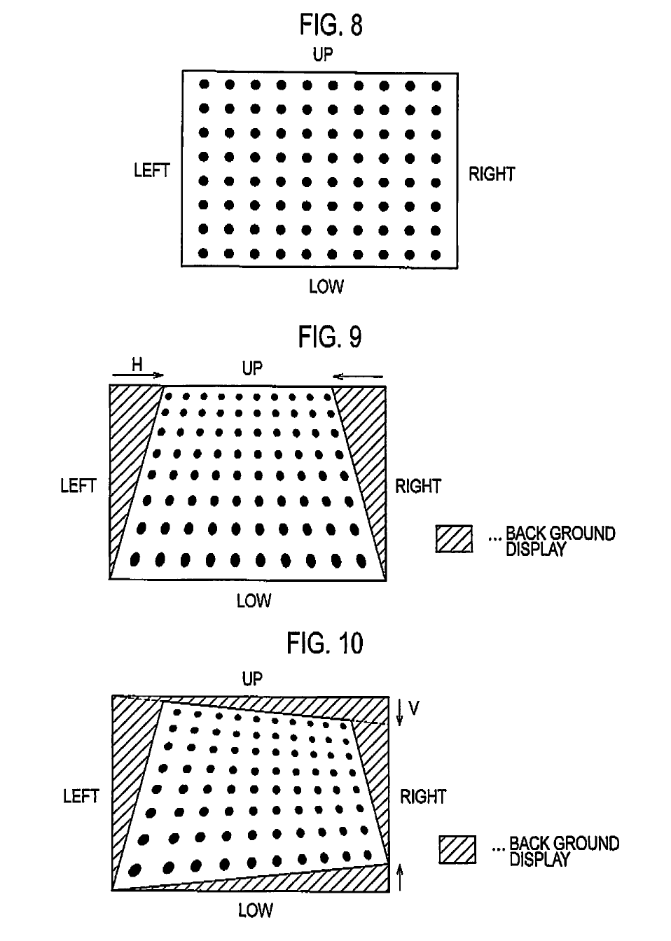

An example of trapezoid correction is described below with reference to FIGS. 8 to 10. Here, description is given of, as an example, a case where an image shown in FIG. 8 is displayed on the projection plane 300 when the projection display apparatus 100 is provided in front of the projection plane 300. That is, FIG. 8 illustrates a case requiring no trapezoid correction function.

As shown in FIG. 9, when the horizontal adjustment signal is inputted from the horizontal adjusting member 112 by the rotation of the horizontal adjusting member 112, the projection display apparatus 100 changes the number of pixels in the horizontal direction. Here, the projection display apparatus 100 reduces the horizontal width of the image so that it becomes narrower toward the upper row of the image. The projection display apparatus 100 controls the horizontal width of the image by, for example, thinning of the pixels in the horizontal direction or pixel interpolation in the horizontal direction. In the case shown in FIG. 9, a suitable image is formed on the projection plane 300 when, for example, the image light is projected from below the projection plane 300.

Note that since the width of the light projected onto the projection plane 300 remains unchanged, a background is displayed in shaded areas shown in FIG. 9. The background is displayed in white or black, for example.

As shown in FIG. 10, when the vertical adjustment signal is inputted from the vertical adjusting member 113 by the rotation of the vertical adjusting member 113, the projection display apparatus 100 changes the number of pixels in the vertical direction. Here, the projection display apparatus 100 reduces the vertical height of the image so that it becomes shorter toward the right-hand column of the image. The projection display apparatus 100 controls the vertical height of the image by, for example, thinning of the pixels in the vertical direction or pixel interpolation in the vertical direction. In the case shown in FIG. 10, a suitable image is formed on the projection plane 300 when, for example, the image light is projected from left below the projection plane 300.

Note that since the width of the light projected onto the projection plane 300 remains unchanged, a background is displayed in shaded areas shown in FIG. 10. The background is displayed in white or black, for example.

(Advantageous Effects)

In the projection display apparatus 100 according to the first embodiment, the horizontal adjusting member 112 and vertical adjusting member 113 used exclusively for the trapezoid correction function are provided in the main body unit 110, thereby simplifying the operation for using the trapezoid correction function in the portable projection display apparatus 100.

More specifically, it should be noted in the first embodiment that the horizontal adjusting member 112 and vertical adjusting member 113 used exclusively for the trapezoid correction function are provided in the main body unit 110, focusing on high usage frequency of the trapezoid correction function in the portable projection display apparatus 100.

### Modified Example 1

Modified example 1 of the first embodiment is described below. The following description is mainly given of differences from the first embodiment.

To be more specific, in modified example 1, configuration examples of the horizontal adjusting member 112 and the vertical adjusting member 113 are described with reference to FIGS. 11 to 14.

As shown in FIG. 11, the horizontal adjusting member 112 and vertical adjusting member 113 have rotating members 112a and 113a, respectively, which are configured to be rotatable. In such a case, the horizontal adjusting member 112 and vertical adjusting member 113 output the horizontal adjustment signal and vertical adjustment signal in response to the rotation of the rotating members 112a and 113a, respectively.

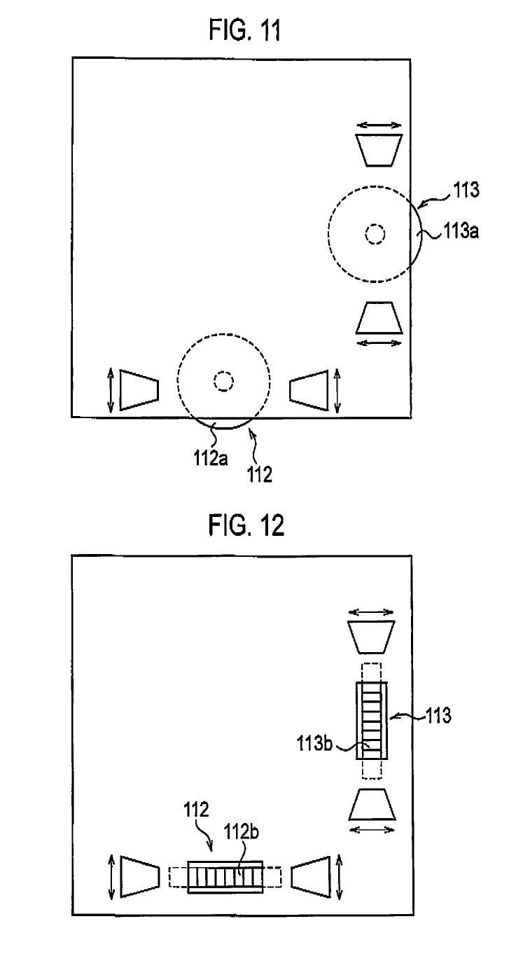

As shown in FIG. 12, the horizontal adjusting member 112 and vertical adjusting member 113 have rotating members 112b and 113b, respectively, which are configured to be rotatable. In such a case, the horizontal adjusting member 112 and vertical adjusting member 113 output the horizontal adjustment signal and vertical adjustment signal in response to the rotation of the rotating members 112b and 113b, respectively.

Note that directions of axes of rotation of rotating members 112b and 113b shown in FIG. 12 are different from those of the rotating members 112a and 113a shown in FIG. 11.

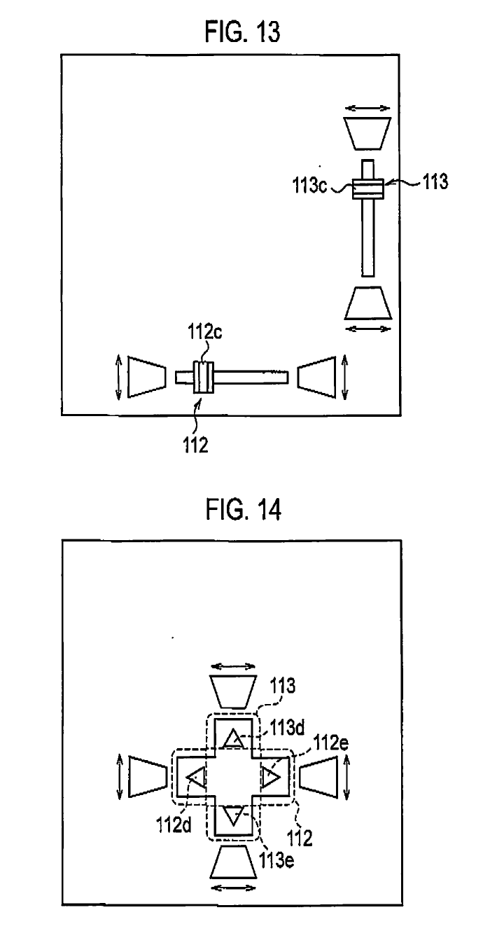

As shown in FIG. 13, the horizontal adjusting member 112 and vertical adjusting member 113 have slidably configured sliding members 112c and 113e, respectively. In such a case, the horizontal adjusting member 112 and vertical adjusting member 113 output the horizontal adjustment signal and vertical adjustment signal in response to the sliding of the sliding members 112c and 113c, respectively.

As shown in FIG. 14, the horizontal adjusting member 112 has operation buttons 112d and 112e each configured be capable of being pressed, and the vertical adjusting member 113 also has operation buttons 113d and 113e each configured be capable of being pressed. In such a case, the horizontal adjusting member 112 outputs the horizontal adjustment signal when the operation button 112d or 112e is pressed, and the vertical adjusting member 113 outputs the vertical adjustment signal when the operation button 113d or 113e is pressed.

### Modified Example 2

Modified example 2 of the first embodiment is described below. The following description is mainly given of differences from the first embodiment.

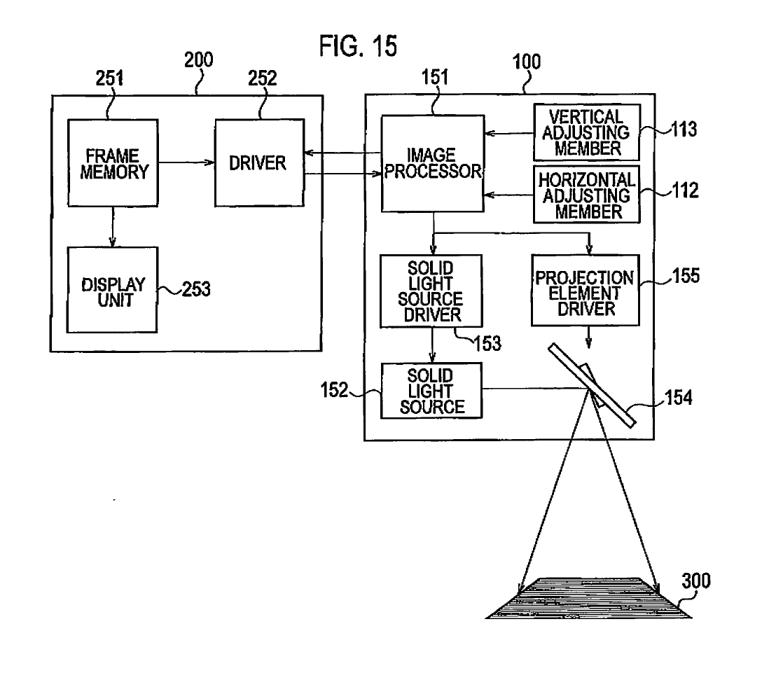

Specifically, in modified example 2, as shown in FIG. 15, a projection display apparatus 100 (an image processor 151) outputs a request to convert an image signal to a terminal 200 in response to a horizontal adjustment signal and a vertical adjustment signal. The projection display apparatus 100 may output to the terminal 200 the horizontal adjustment signal and vertical adjustment signal as the request to convert the image signal.

Note that the terminal 200 changes the number of pixels in the horizontal direction and the number of pixels in the vertical direction in response to the request to convert the image signal. The terminal 200 outputs the converted image signal to the projection display apparatus 100 (the image processor 151). The converted image signal is a signal obtained by changing the number of pixels in the horizontal direction and the number of pixels in the vertical direction.

### Modified Example 3

Modified example 3 of the first embodiment is described below. The following description is mainly given of differences from the first embodiment.

Specifically, in modified example 3, a trapezoid correction function is realized not by conversion of the image signal but by controlling a scan angle for a projection element 154.

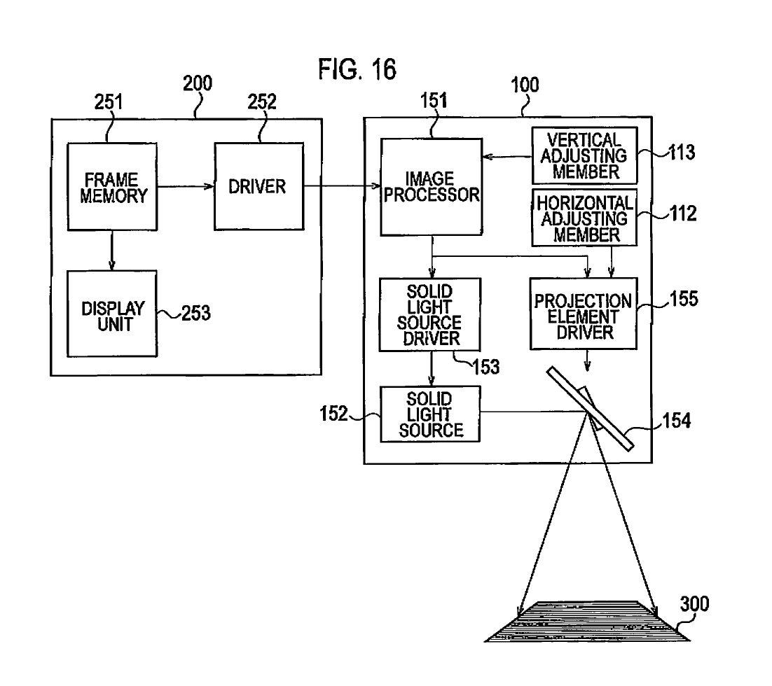

As shown in FIG. 16, a projection element driver 155 acquires a horizontal adjustment signal from a horizontal adjusting member 112 when a scanning direction of the projection element 154 is the horizontal direction. Note that the projection element driver 155 may acquire a vertical adjustment signal from a vertical adjusting member 113 when the scanning direction of the projection element 154 is the vertical direction.

The projection element driver 155 controls the trapezoid correction function based on the horizontal adjustment signal or the vertical adjustment signal. To be more specific, the projection element driver 155 controls a horizontal scan angle for the projection element 154 based on the horizontal adjustment signal when the scanning direction of the projection element 154 is the horizontal direction. On the other hand, the projection element driver 155 controls a vertical scan angle for the projection element 154 based on the vertical adjustment signal when the scanning direction of the projection element 154 is the vertical direction.

In modified example 3, description is given of an example of control when the scanning direction of the projection element 154 is the horizontal direction.

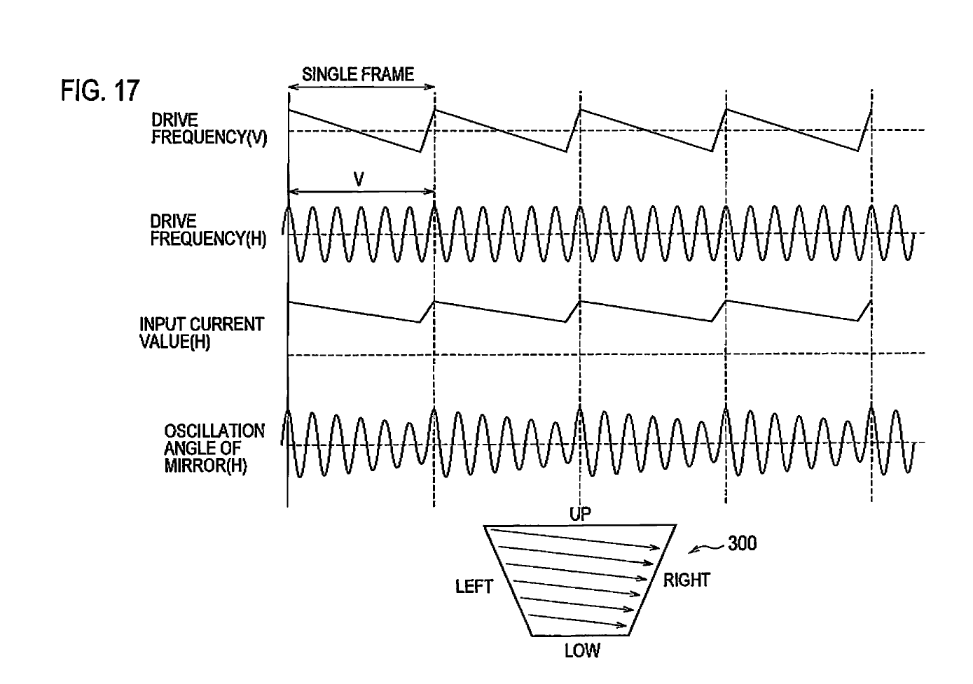

First, with reference to FIG. 17, description is given of a case where a width of an image is reduced so that it becomes narrower toward the lower row of the image. Note that a vertical drive frequency (V) of the projection element 154 and a horizontal drive frequency (H) of the projection element 154 are not particularly changed. The projection element driver 155 gradually reduces an oscillation angle (H) of a mirror provided in the projection element 154 by gradually reducing a horizontal input current value (H) of the projection element 154. Thus, the scan angle for the projection element 154 is reduced toward the lower row of the image.

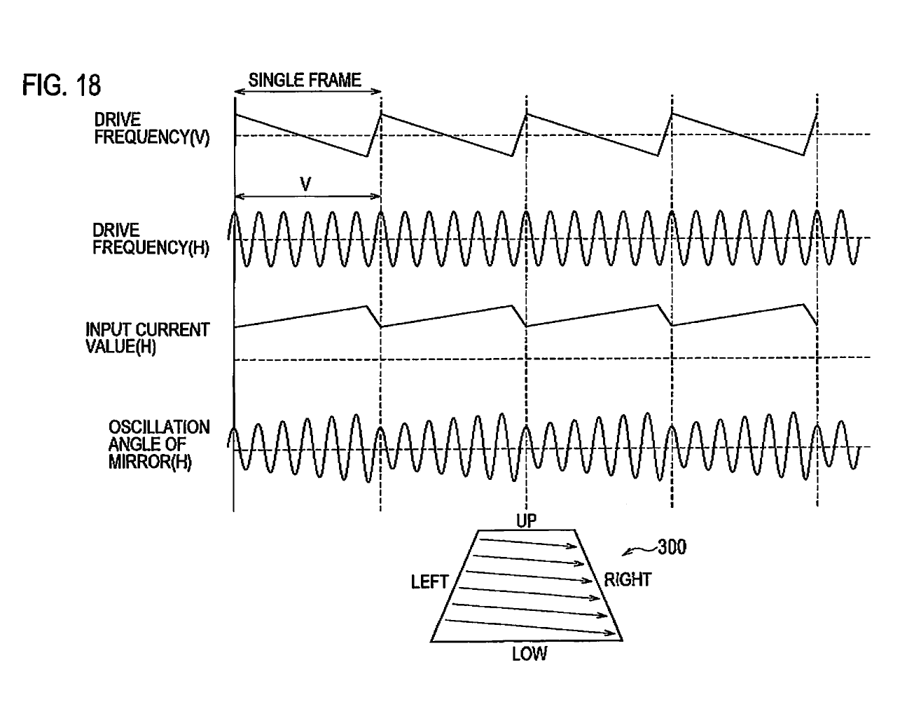

Second, with reference to FIG. 18, description is given of a case where a width of an image is reduced so that it becomes narrower toward the upper row of the image. Note that the vertical drive frequency (V) of the projection element 154 and the horizontal drive frequency (H) of the projection element 154 are not particularly changed. The projection element driver 155 gradually increases the oscillation angle (H) of the mirror provided in the projection element 154 by gradually increasing the horizontal input current value (H) of the projection element 154. Thus, the scan angle for the projection element 154 is increased toward the lower row of the image.

As described above, in the case where the scanning direction of the projection element 154 is the horizontal direction, it is preferable that the image processor 151 changes the number of pixels in the vertical direction based on the vertical adjustment signal inputted from the vertical adjusting member 113.

Note that the case where the scanning direction of the projection element 154 is the vertical direction is the same as the case where the scanning direction of the projection element 154 is the horizontal direction, and therefore description thereof is omitted.

### Second Embodiment

A second embodiment is described below with reference to the drawings. The following description is mainly given of differences from the first embodiment.

In the second embodiment, a projection display apparatus 100 forms on a projection plane 300 at least two or more correction shapes as an image formed by light projected onto the projection plane 300. The correction shapes are shapes obtained by deforming a predetermined reference shape according to projection angles.

(Functions of Display System)

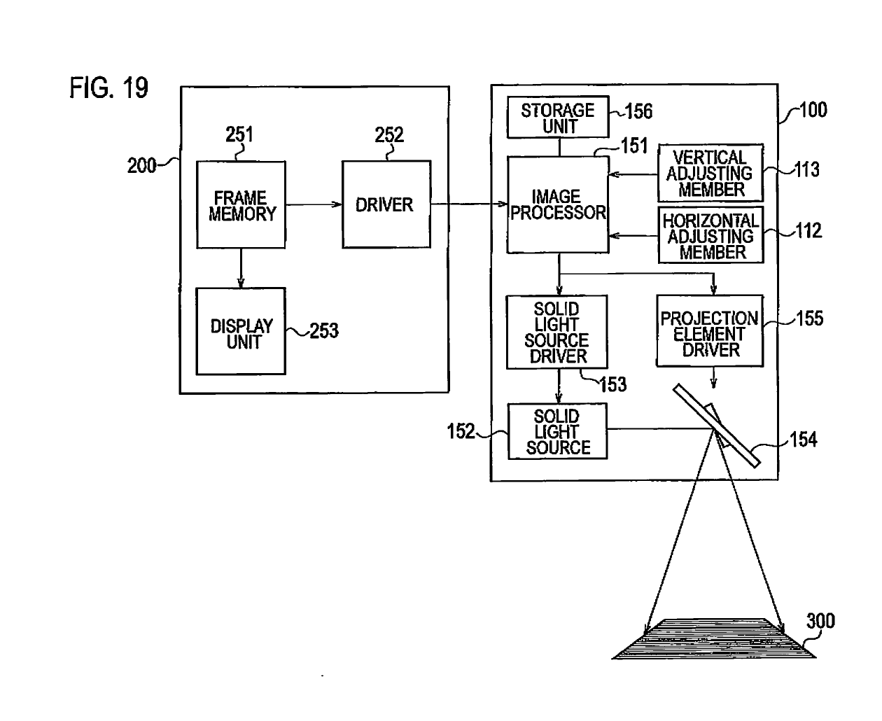

Functions of a display system according to the second embodiment are described below with reference to the drawing. FIG. 19 is a diagram showing the functions of the display system according to the second embodiment. It should be note that, the same reference signs are used to denote the same components as those of FIG. 7 in FIG. 19.

As shown in FIG. 19, the projection display apparatus 100 further includes a storage unit 156 in addition to the configuration shown in FIG. 7.

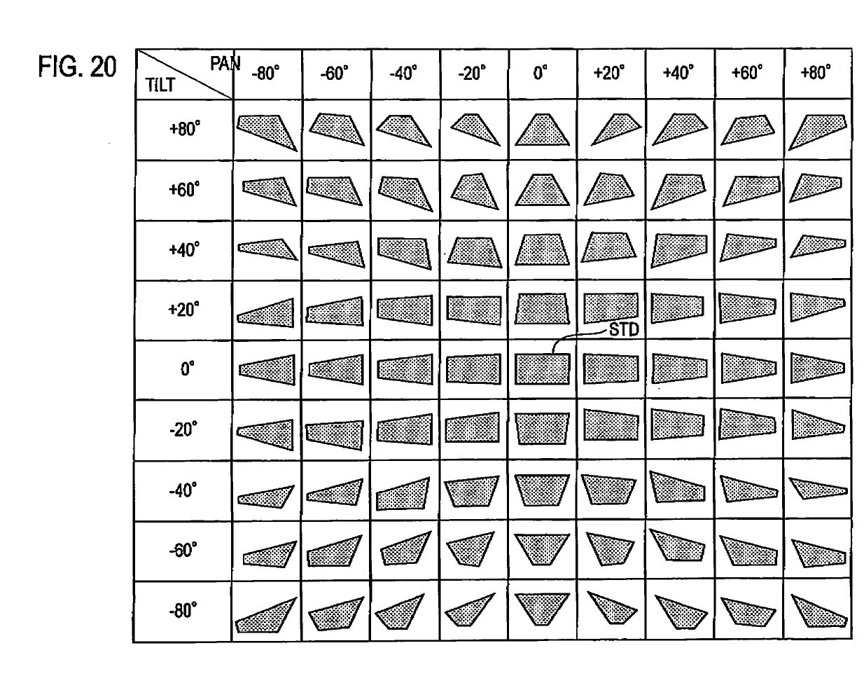

The storage unit 156 stores multiple correction shapes. Specifically, as shown in FIG. 20, the storage unit 156 stores projection angles at which the projection element 154 projects the light onto the projection plane 300 and the multiple correction shapes obtained by deforming the predetermined reference shape according to the projection angles in association with each other.

Here, the predetermined reference shape is preferably a shape similar to a light projection area (e.g., a rectangle with an aspect ratio of 4:3 or a rectangle with an aspect ratio of 16:9) which is formed by the light projected onto the projection plane 300 when the projection angle is a reference projection angle.

Each of the correction shapes is one deformed so that the predetermined reference shape is formed on the projection plane 300 when the projection angle is the one associated with the correction shape. The correction shape is preferably a shape similar to a light projection area (e.g., a rectangle with an aspect ratio of 4:3 or a rectangle with an aspect ratio of 16:9) which is formed by the light projected onto the projection plane 300 when the projection angle is the one associated with the correction shape.

In the second embodiment, as shown in FIG. 20, the projection angle is expressed by a pan angle from the reference projection angle and a tilt angle from the reference projection angle. The reference projection angle is one at which both of the pan angle and tilt angle are 0°. The reference projection angle is, for example, one at which the optical axis of the projection display apparatus 100 coincides with the normal to the projection plane 300. Note that the correction shape associated with the reference projection angle is hereinafter referred to as the “correction shape STD” for the purpose of distinguishing from the other correction shapes.

The image processor 151 described above controls the solid light source driver 153 and the projection element driver 155 so that at least two or more correction shapes, among the multiple correction shapes, are formed on the projection plane 300 as the image formed by the light projected onto the projection plane 300. That is, the image processor 151 indirectly controls the solid light source 152 and the projection element 154 so that at least two or more correction shapes, among the multiple correction shapes, are formed on the projection plane 300.

(Display Example of Correction Shape)

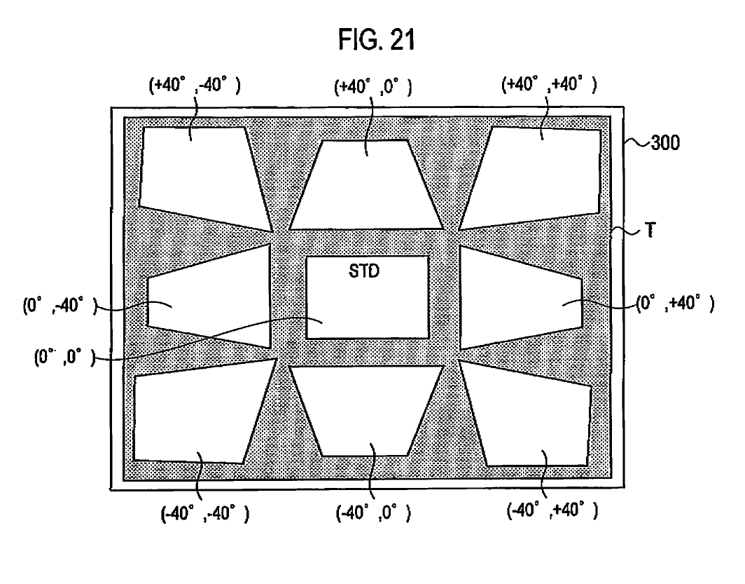

Description is given below of display examples of the correction shapes according to the second embodiment with reference to the drawings. FIGS. 21 to 25 are diagrams showing the display examples of the correction shapes according to the second embodiment.

As shown in FIG. 21, when the projection angle is the reference projection angle (tilt angle=0° and pan angle=0°, the correction shape STD is formed at the center of a light projection area T on the projection plane 300. Note that since the projection angle is the reference projection angle, the correction shape STD on the projection plane 300 is the same as the predetermined reference shape. Moreover, correction shapes associated with projection angles at a first interval (e.g., tilt angle=±40° and pan angle=±40°) from the projection angle (tilt angle=0° and pan angle=0°) associated with the center correction shape formed at the center of the light projection area T are formed around the center correction shape on the projection plane 300.

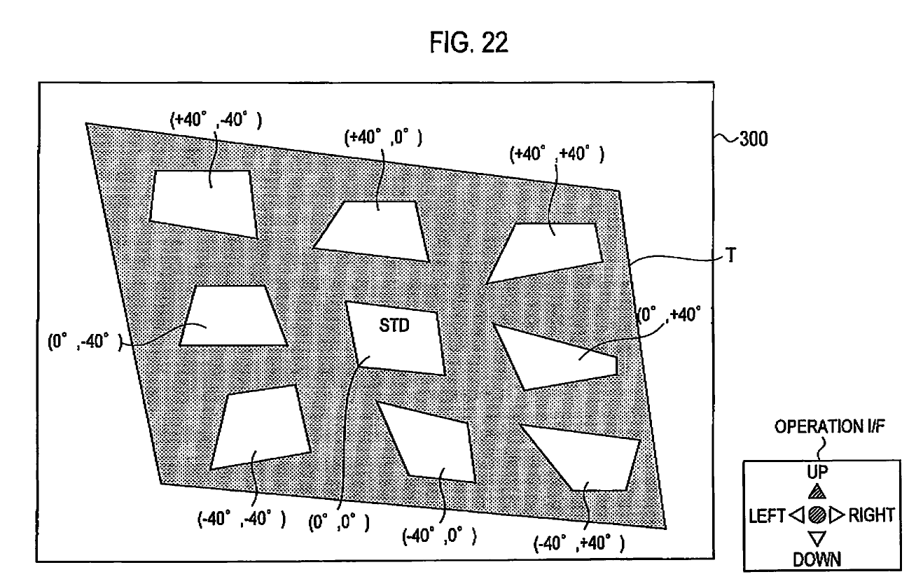

As shown in FIG. 22, when the projection angle is different from the reference projection angle (tilt angle=0° and pan angle=0°), the correction shape STD on the projection plane 300 has a shape different from the predetermined reference shape.

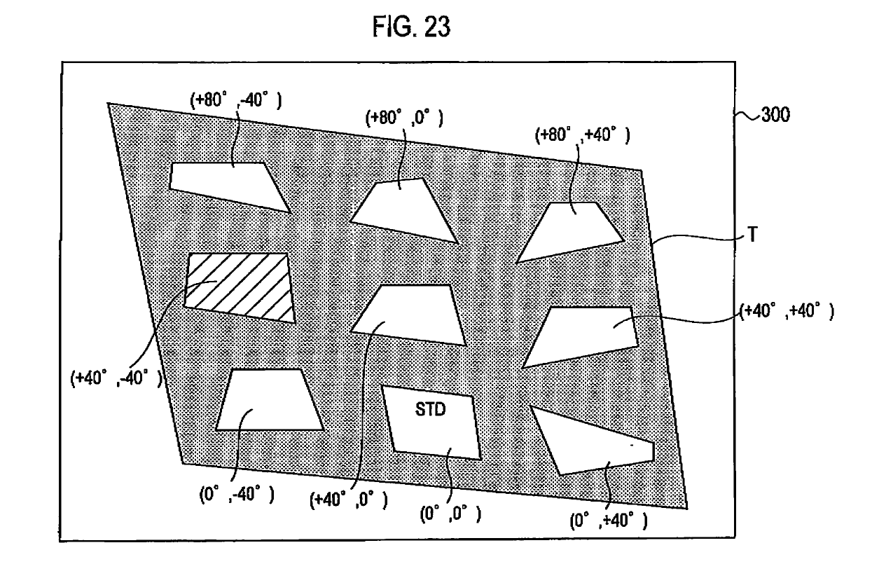

When “UP” is entered using an operation I/F in the state shown in FIG. 22, the list of correction shapes formed on the projection plane 300 is scrolled on the projection plane 300 as shown in FIG. 23. To be more specific, the correction shape associated with the projection angle (tilt angle=±40° and pan angle=0°) is arranged at the center of the light projection area T on the projection plane 300. Moreover, the correction shapes associated with the projection angles at the first interval (e.g., tilt angle=±40° and pan angle=±40°) from the projection angle (tilt angle=±40° and pan angle=0°) associated with the center correction shape formed at the center of the light projection area T are formed around the center correction shape on the projection plane 300.

Note that the horizontal adjusting member 112 and vertical adjusting member 113 can be used as the operation I/F. Moreover, keys (e.g., cursor keys) provided on the terminal 200 may be used as the operation I/F. Furthermore, keys (e.g., cursor keys) provided on a remote controller may be used as the operation I/F.

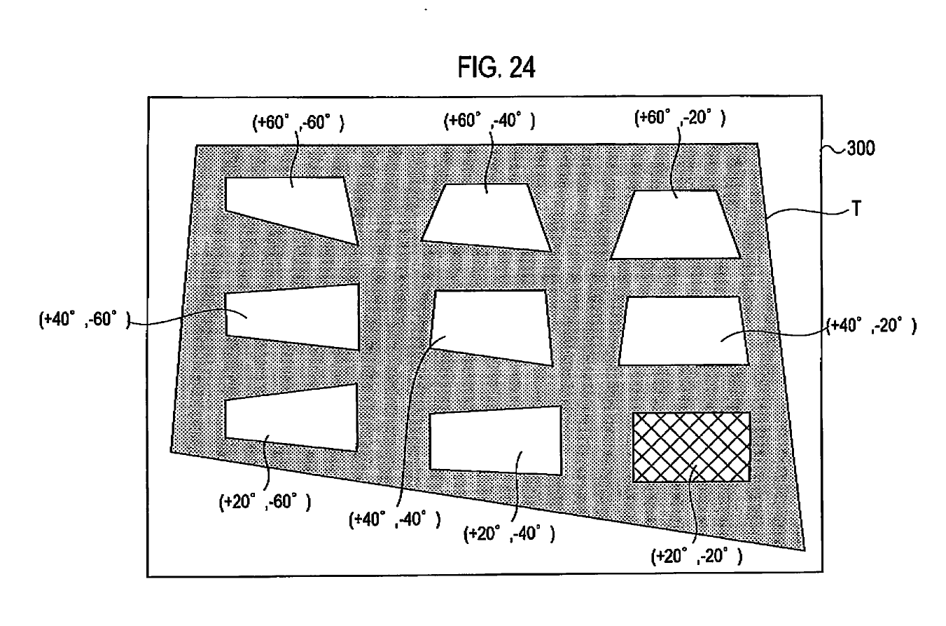

When the correction shape associated with the projection angle (tilt angle=+40° and pan angle=−40°) is selected using the operation I/F in the state shown in FIG. 23, the correction shape associated with the projection angle (tilt angle=+40° and pan angle=−40°) is arranged at the center of the light projection area T on the projection plane 300 as shown in FIG. 24. The image processor 151 controls the trapezoid correction function based on the projection angle (tilt angle=+40° and pan angle=−40°) associated with the center correction shape formed at the center of the light projection area T, thereby correcting the light projection area T to be the shape similar to the center correction shape.

Moreover, the correction shapes associated with the projection angles at a second interval (e.g., tilt angle=±20° and pan angle=±20°) from the projection angle (tilt angle=+40° and pan angle=−40°) associated with the center correction shape formed are formed around the center correction shape on the projection plane 300. It should be noted that the second interval is narrower than the first interval.

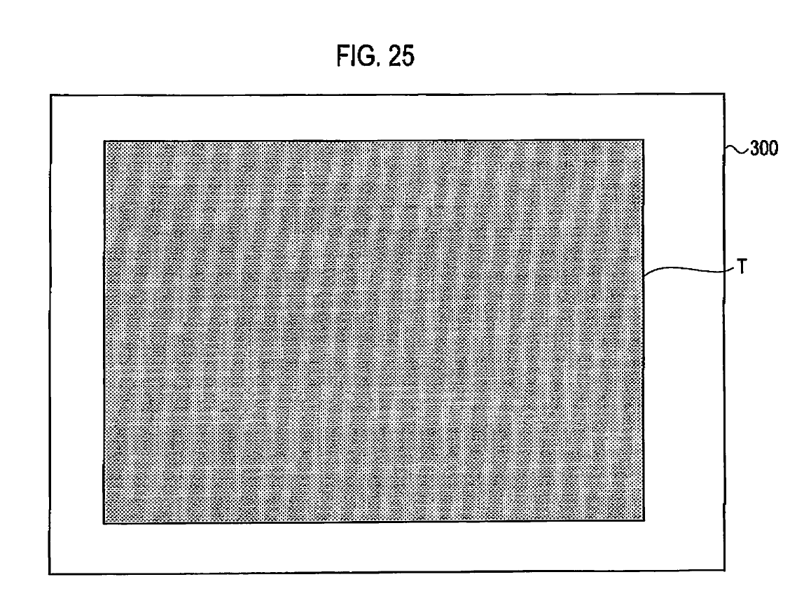

When the correction shape associated with the projection angle (tilt angle=+40° and pan angle=−40°) is finally selected using the operation I/F in the state shown in FIG. 24, the light projection area T is corrected to be the shape similar to the correction shape associated with the projection angle (tilt angle=+20° and pan angle=−20°) on the projection plane 300 as shown in FIG. 25. Specifically, the image processor 151 controls the trapezoid correction function based on the projection angle (tilt angle=±20° and pan angle=−20°) associated with the finally selected correction shape.

(Advantageous Effects)

In the second embodiment, the projection display apparatus 100 forms on the projection plane 300 the correction shapes, which are obtained by deforming the predetermined reference shape according to the projection angle, as the image formed by the light projected onto the projection plane 300. Accordingly, correction shapes similar to the predetermined reference shape need only be selected on the projection plane 300, thus facilitating image adjustment (trapezoid correction).

### Third Embodiment

A third embodiment is described below with reference to the drawings. The following description is mainly given of differences from the first embodiment.

In the third embodiment, a projection display apparatus 100 forms on a projection plane 300 a vertical guide line and a horizontal guide line as a start-up image when the projection display apparatus 100 is started. Here, the vertical guide line forms a vertical line when processing of an image adjustment function (trapezoid correction function) is completed and the horizontal guide line forms a horizontal line when processing of the image adjustment function (trapezoid correction function) is completed.

(Display Example of Start-Up Image)

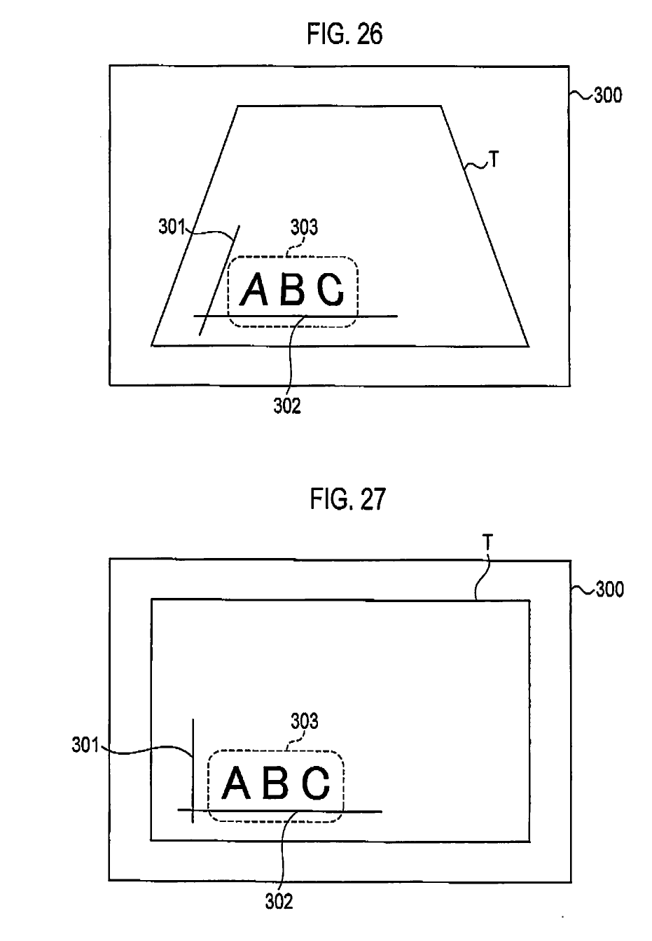

Description is given below of display examples of the start-up image according to the third embodiment with reference to the drawings. FIGS. 26 and 27 are diagrams showing the display examples of the start-up image according to the third embodiment. To be more specific, FIG. 26 shows a start-up image before completion of processing of the image adjustment function (trapezoid correction function), while FIG. 27 shows a start-up image after the completion of processing of the image adjustment function (trapezoid correction function).

As shown in FIGS. 26 and 27, the projection display apparatus 100 forms a vertical guide line 301 and a horizontal guide line 302 on the projection plane 300 as the start-up image when the projection display apparatus 100 is started. The projection display apparatus 100 may also form on the projection plane 300 an initial image 303 such as a logo in addition to the vertical guide line 301 and the horizontal guide line 302 as the start-up image.

In other words, the image processor 151 described above controls the solid light source driver 153 and the projection element driver 155 so that the vertical guide line, the horizontal guide line and the initial image 303 are formed on the projection plane 300 as the start-up image. That is, the image processor 151 indirectly controls the solid light source 152 and the projection element 154 so that the vertical guide line, the horizontal guide line and the initial image 303 are formed on the projection plane 300.

Here, the vertical guide line 301 forms a vertical line when the processing of the image adjustment function (trapezoid correction function) is completed. Also, the horizontal guide line 302 forms a horizontal line when the processing of the image adjustment function (trapezoid correction function) is completed.

Accordingly, in the start-up image shown in FIG. 26, the vertical guide line 301 is not vertical and the horizontal guide line 302 is not horizontal. On the other hand, in the start-up image shown in FIG. 27, the vertical guide line 301 is vertical and the horizontal guide line 302 is horizontal.

Note that, in the third embodiment, there are one vertical guide line 301 and one horizontal guide line 302. However, the embodiment of the present invention is not limited thereto. Thus, there may be more than one vertical guide line 301 and more than one horizontal guide line 302.

Furthermore, a tetragon may be formed by a pair of vertical guide lines 301 and a pair of horizontal guide lines 302. That is, the pair of vertical guide lines 301 and the pair of horizontal guide lines 302 form a rectangular shape when the processing of the image adjustment function (trapezoid correction function) is completed.

(Advantageous Effects)

In the third embodiment, the projection display apparatus 100 forms on the projection plane 300 the vertical guide line 301 and the horizontal guide line 302 as the start-up image. Accordingly, the vertical guide line 301 needs only be aligned with the vertical direction and the horizontal guide line 302 needs only be aligned with the horizontal direction on the projection plane 300, thus facilitating image adjustment (trapezoid correction).

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

For example, conversion of the image signal and control of the scan angle may be combined together. In the case where the scanning direction of the projection element 154 is the horizontal direction, the trapezoid correction function in the horizontal direction may be realized by controlling the scan angle for the projection element 154, and the trapezoid correction function in the vertical direction may be realized by converting the image signal. Similarly, in the case where the scanning direction of the projection element 154 is the vertical direction, the trapezoid correction function in the vertical direction may be realized by controlling the scan angle for the projection element 154, and the trapezoid correction function in the horizontal direction may be realized by converting the image signal.

In the embodiments described above, the portable projection display apparatus 100 has been described as an example. However, the projection display apparatus 100 may also be a stationary projection display apparatus.

Although no detailed description is given of signal conversion for the trapezoid correction function in the above embodiments, conversion of the image signal besides the number of pixels is required, as a matter of course, for the trapezoid correction.

In the above embodiments, the description has been mainly given of the case where the adjusting members used exclusively for the image adjustment function are provided in the projection display apparatus 100. However, the embodiments of the present invention are not limited thereto. Thus, the operation I/F used to operate the image adjustment function may be provided in the terminal 200. The operation I/F provided in the terminal 200 does not have to be used exclusively for operating the image adjustment function.

Although the solid light source has been described as the light source in the above embodiments, the light source is not limited thereto. Specifically, the light source may be a UHP lamp or a xenon lamp.

### INDUSTRIAL APPLICABILITY

The present invention can provide a projection display apparatus and a display system, which are capable of simplifying an operation for adjusting an image on a projection plane.

1. A projection display apparatus comprising:
a main body unit including a light source and a projection element which projects light emitted from the light source to a projection plane, wherein
the projection element is provided inside the main body unit, and
the main body unit further includes an adjusting member used exclusively for operation of an image adjustment function to adjust an image on the projection plane, the image being formed by the light emitted from the projection element.

2. The projection display apparatus according to claim 1, further comprising:
a supporting member which supports the main body unit rotatably around a plurality of axes; and
a fixing member which fixes the main body unit and the supporting member to installation sites.

3. The projection display apparatus according to claim 1, further comprising:
an image processor which controls the image adjustment function based on an adjustment signal inputted from the adjusting member, wherein
the image projected onto the projection plane includes a plurality of pixels each having coordinates determined by a row in the horizontal direction and a column in the vertical direction, and
the image processor changes the number of pixels in the horizontal direction and the number of pixels in the vertical direction by converting an image signal inputted from an external device.

4. The projection display apparatus according to claim 1, further comprising:
an image processor which controls the image adjustment function based on an adjustment signal inputted from the adjusting member, wherein
the image projected onto the projection plane including a plurality of pixels each having coordinates determined by a row in the horizontal direction in the column in the vertical direction,
the image processor outputs, as a request to convert the image signal, the adjustment signal inputted from the adjusting member, to an external device,
the image processor acquires the converted image signal from the external device, and
the converted image signal is a signal obtained by changing the number of pixels in the horizontal direction and the number of pixels in the vertical direction.

5. The projection display apparatus according to claim 1, further comprising:
an image processor which controls the image adjustment function based on an adjustment signal inputted from the adjusting member, wherein
the light source is a solid light source,
the projection element scans the projection plane in a predetermined scanning direction for each of a plurality of pixels each having coordinates determined by a row in the horizontal direction and a column in the vertical direction, and
the image processor controls a scan angle for the projection element in the predetermined scanning direction.

6. The projection display apparatus according to claim 1, further comprising:
a storage unit which stores projection angles at which the projection element projects the light onto the projection plane and a plurality of correction shapes in association with each other, the plurality of correction shapes obtained by deforming a predetermined reference shape according to the projection angles; and
an image processor which controls the light source and the projection element so that at least two or more of the plurality of correction shapes are formed on the projection plane as an image formed by the light projected onto the projection plane.

7. The projection display apparatus according to claim 1, further comprising:
an image processor which controls the light source and the projection element so that an image is formed with the light projected onto the projection plane, wherein
the image processor controls the light source and the projection element so that a vertical guide line and a horizontal guide line are formed on the projection plane as a start-up image when the projection display apparatus is started, the vertical guide line forming a vertical line when processing of the image adjustment function is completed and the horizontal guide line forming a horizontal line when processing of the image adjustment function is completed.

8. A display system comprising at least a projection display apparatus including a light source and a projection element which projects light emitted from the light source to a projection plane, the display system further comprising an adjusting member used for operation of an image adjustment function to adjust an image on the projection plane, the image being formed by the light emitted from the projection element, wherein
the projection element is provided in the projection display apparatus.
